(19) United States
(12) Patent Application Publication
(10) Pub. No.: US 2010/0204940 A1
(43) Pub. Date: Aug. 12, 2010

(54) METHOD AND SYSTEM OF COMMONALITY ANALYSIS FOR LOTS WITH SCRAPPED WAFER

(75) Inventors: Gasner J. Barthold, Fishkill, NY (US); Hari V. Mallela, Poughquag, NY (US); Yunsheng Song, Poughkeepsie, NY (US)

Correspondence Address: INTERNATIONAL BUSINESS MACHINES CORPORATION;DEPT. 18G, BLDG. 321-482, 2070 ROUTE 52, HOPEWELL JUNCTION, NY, 12533, US

(73) Assignee: International Business Machines Corporation, Armonk, NY (US)

(21) Appl. No.: 12/367,564

(22) Filed: Feb. 9, 2009

(51) Int. Cl. G06F 7/06; G06F 17/30; G06F 19/00

(52) U.S. Cl. 702/82; 707/E17.044; 707/E17.014; 707/E17.046

(57) ABSTRACT

According to an embodiment of the present invention is to provide methods to evaluate the impact of scrapped wafers on the remaining wafers in a lot by using scrap codes and statistical models. An embodiment of the present invention provides a method to obtain a baseline lot population by using cluster analysis model and functional limited yields. The functional limited yields may be for example chain limited yield, dc limited yield, or ac abist limited yield. By utilizing statistical modeling it is possible to determine which failures have an impact on the lot yield and require rework for the lot. In addition by monitoring the impact of failures, it is possible to determine if corrective actions need to be taken for lots that passed through a process prior to correction of the fault.

### BACKGROUND

The manufacture of integrated circuits involves billions of dollars in expense and errors may result in significant losses. The inventors have observed that mis-process/events occur during chip fabrication. The impacted wafers are often scrapped when there is a mis-process or event that could potentially result in a low wafer test yield. These events may include a broken wafer which may occur in either a batch process or a single wafer process or during transport from one process to the next process.

During process the impacted wafers are removed and the rest of the lot will move through the line and arrive at test. At test the inventors have noticed that significant yield variability in the yield distribution. As a result the cost of rework, scrap and decreased customer satisfaction have a significant impact on profitability. For example the inventors have determined that a wafer which fails or breaks in a batch process may impact the yield of the wafers in that lot. For example during a metallization process, a broken wafer may cause wafer fragments to be distributed onto the wafers in the batch process, thus contaminating the entire batch. Similarly, if a wafer breaks in a single wafer process, the lot as a whole may be unaffected. The inventors have determined that it would be of value to be able to determine at the time or at least prior to testing if an error or wafer break occurs what corrective actions should be taken to minimize the costs in the processing of the wafers.

### SUMMARY

According to an embodiment of the present invention is to provide methods to evaluate the impact of scrapped wafers on the remaining wafers in a lot by using scrap codes and statistical models. An embodiment of the present invention provides a method to obtain a baseline lot population by using cluster analysis model and functional limited yields. The functional limited yields may be for example chain limited yield, dc limited yield, or ac abist limited yield.

By using a statistical model, such as MANOVA (Multivariate Analysis of Variance), to compare the baseline lot population and lots which have scrapped wafers, it is possible to determine which error codes, require additional actions. If there is no significant difference between the baseline lot population and lots which had scrapped wafers, no additional rework may be required. If there is a significant difference between the baseline lot population and lots which had scrapped wafers further analysis may be required to detect which process steps caused the difference.

### BRIEF DESCRIPTION OF THE SEVERAL VIEWS OF THE DRAWINGS

FIG. 1 is a flow diagram of a method for determining the corrective actions to take for an error code according to an embodiment of the invention.

FIG. 2 illustrates an example of Vdd shorts yield by impacted scrapped wafers.

FIG. 3 is a representation of a Foup.

FIG. 4 is a flow diagram of a method for determining what corrective action to take for a lot based on the error code for a wafer according to an embodiment of the invention.

FIG. 5 shows a general-purpose computing device in the form of a conventional personal computer incorporating an embodiment of the invention.

### DETAILED DESCRIPTION

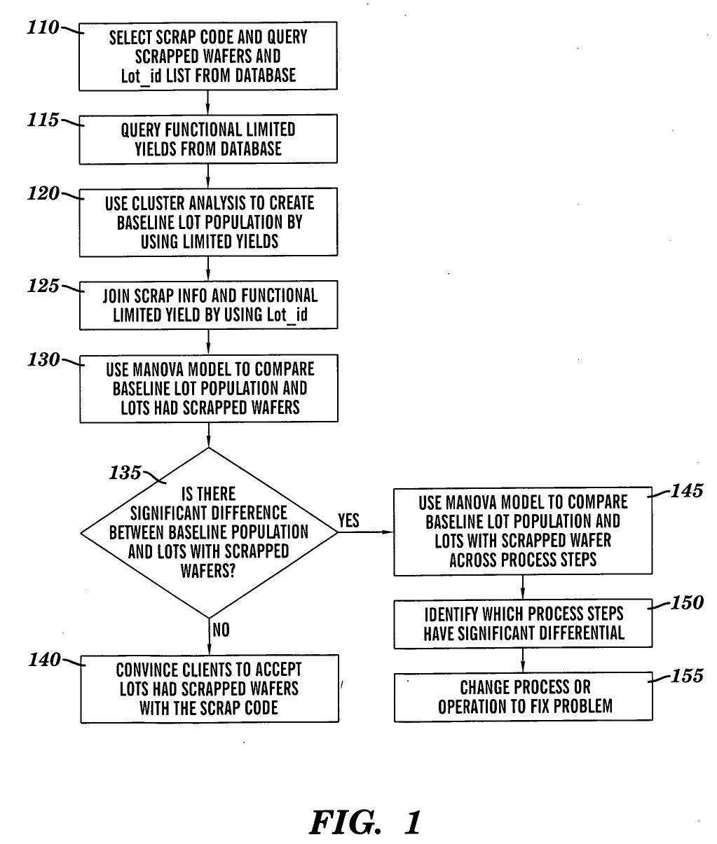

With reference now to FIG. 1 illustrates a flow diagram of a method 100 for determining the corrective actions to take for an error code according to an embodiment of the invention. Activity 110 may be to select a scrap code and query scrapped wafer and Lot_id list from a database. Activity 110 is used to identify various scrap codes and the lots that they have affected. Activity 115 is to query the functional limited yields from the database. Activity 120 is to use cluster analysis to create baseline lot populations by using the limited yields of Activity 115. Activity 125 is to join the scrap information of 110 and the functional limited yield of 120 by using the Lot_id. Activity 130 is to use MANOVA model to compare baseline lot population and lots which had scrapped wafers. Activity 135 is to determine if there is a significant difference between baseline population and lots that had scrapped wafers. If there is a significant difference then Activity 145 uses MANOVA models to compare the baseline lot population and lots that had scrapped wafers across the process steps. Activity 150 is to identify those process steps that have significant yield differentials. Activity 155 is to change the identified processes or operations to reduce the errors. If a significant difference is not found in Activity 135, activity 140 may be to work with the client to show why the error will not impact the quality of the remainder of the lot.

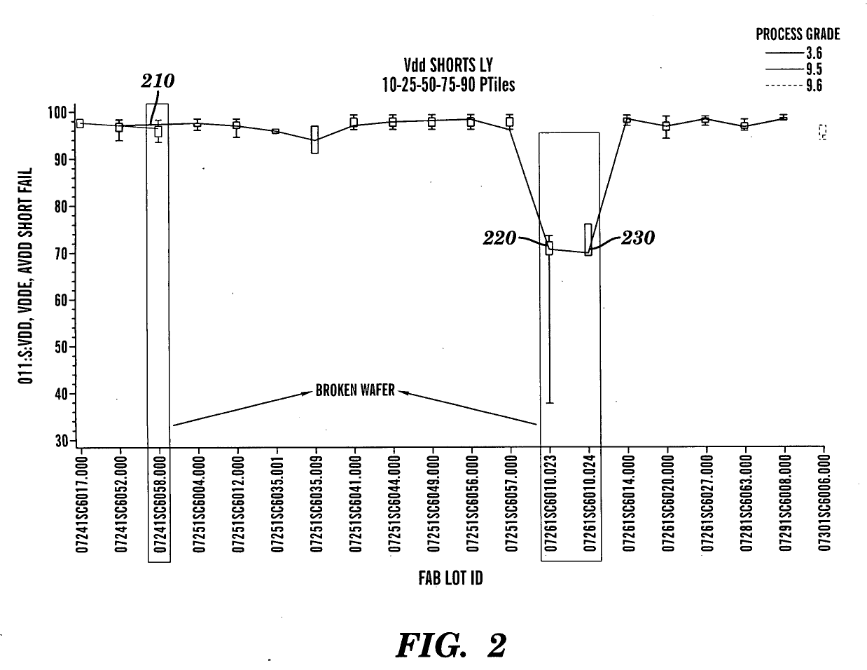

FIG. 2 illustrates an example of Vdd shorts yield by impacted scrapped wafers. Using the method 100 of FIG. 1 the impact of broken wafers can be shown. Broken wafers 210 illustrates a case where the impact from the broken wafer on the yield is minimal. Broken wafers 220 and 230 shows a case where the impact is significant. As shown in FIG. 1, Activity 134 would submit that the process where broken wafer 210 occurs does not have a significant difference from the baseline population and therefore Activity 140 may be to convince the clients or management to accept the lots which had the scrapped wafer. However, as shown broken wafer lots 220 and 230 indicate a significant difference from the baseline population. Therefore the processes in which the lots associated with broken wafers 220 and 230 are submitted to Activities 145, 150 and 155. In addition it may be that activity 145 may indicate that the impact may affect more than one lot.

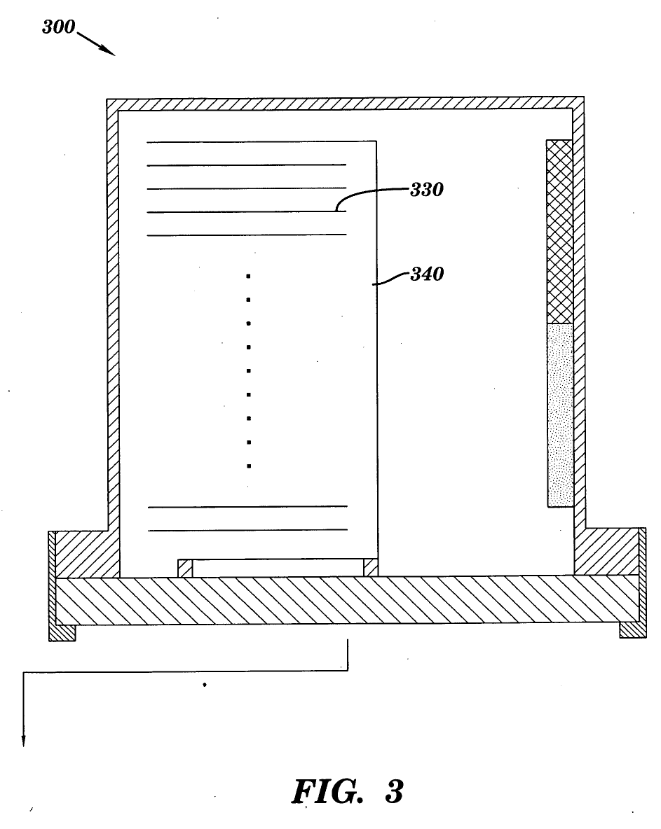

FIG. 3 is a representation of a foup 300. Foups such as foup 300 are one of the common means by which wafers are transported from one process to another. One means by which wafer breaks are detected is visual inspection during transportation. Foup 300 is holds a number of wafers 330 within a retainer 340 and seals the wafers during transportation.

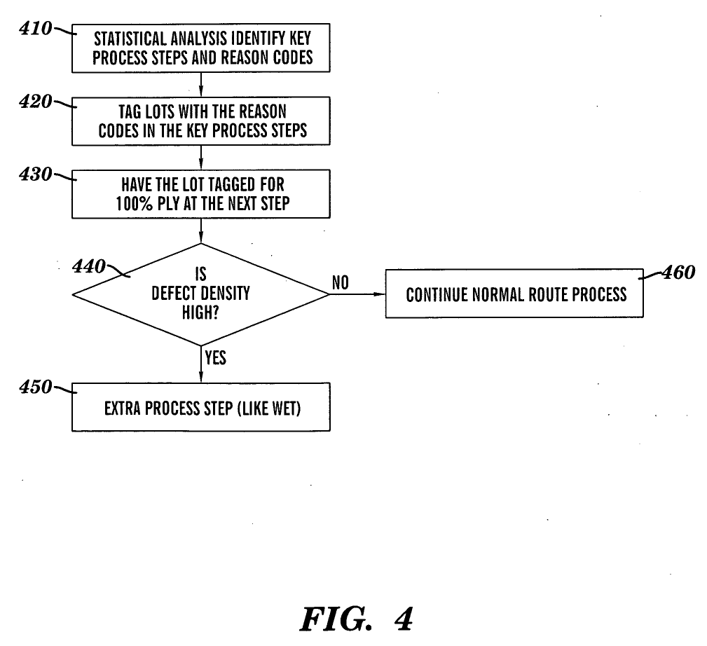

FIG. 4 is a flow diagram of a method 400 for determining what corrective action to take for a lot based on the error code for a wafer according to an embodiment of the invention. Activity 410 may be to utilize statistical analysis to identify key process steps and reason codes. Activity 420 may be to tag lots with reason codes in key process steps. Activity 430 may be to have the lot tagged for 100% process limited yield (PLY) inspection at the next step. Activity 440 is to determine if the defect density is high. If the defect density is high Activity 450 may be to subject the lot to an extra process such as WET process. If the defect density is not high, then Activity 460 may be to continue the normal route process. In addition to sending the specific lot to an extra process in Activity 440, it may be that additional lots may need to be process through a corrective process step such as WET.

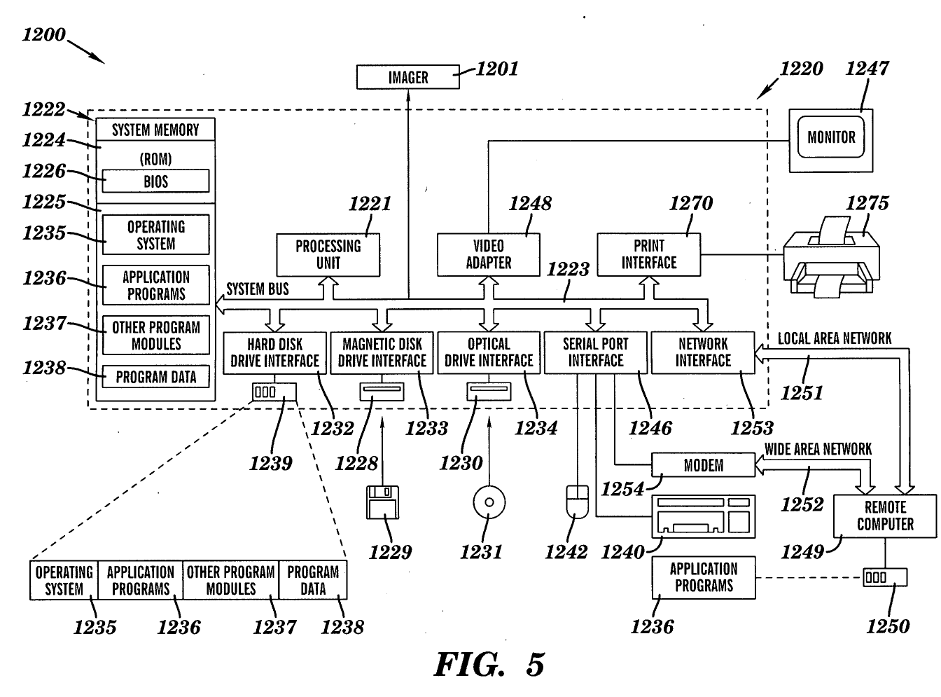

FIG. 5 shows a general-purpose computing device such as a personal computer 1220, which includes a processing unit 1221, a system memory 1222, and a system bus 1223 that couples the system memory 1222 and other system components to processing unit 1221. System bus 1223 may be any of several types, including a memory bus or memory controller, a peripheral bus or a local bus, and may use any of a variety of bus structures. System memory 1222 includes read-only memory (ROM) 1224 and random-access memory (RAM) 1225. A basic input/output system (BIOS) 1226, stored in ROM 1224, contains the basic routines that transfer information between components of personal computer 1220. BIOS 1226 may also contain start-up routines for the system. Personal computer 1220 further includes hard disk drive 1239, magnetic disk drive 1228 for reading from and writing to a removable magnetic disk 1229, and optical disk drive 1230 for reading from and writing to a removable optical disk 1231 such as a CD-ROM (compact disc-read only memory), DVD (digital versatile disc or digital video disc) or other optical medium. Hard disk drive 1239, magnetic disk drive 1228, and optical disk drive 1230 are connected to system bus 1223 by a hard-disk drive interface 1232, a magnetic-disk drive interface 1233, and an optical-drive interface 1234, respectively. The drives and their associated computer-readable media provide nonvolatile storage of computer-readable instructions, data structures, program modules and other data for personal computer 1220. Although the environment described herein employs a hard disk drive 1239, a removable magnetic disk 1229 and a removable optical disk 1231, those skilled in the art will appreciate that other types of computer-readable media that may store data accessible by a computer may also be used in the operating environment. Such media may include magnetic cassettes, flash-memory cards, DVD, Bernoulli cartridges, RAMs (random access memory), ROMs, and the like.

Program modules may be stored on the hard disk drive 1239, magnetic disk 1229, optical disk 1231, ROM 1224 and RAM 1225. Program modules may include operating system 1235, one or more application programs 1236, other program modules 1237, and program data 1238. The application programs 1236 may include such programs as MANOVA. A user may enter commands and information into personal computer 1220 through input devices such as a keyboard 1240 and a pointing device 1242. Other input devices (not shown) may include a microphone, joystick, game pad, satellite dish, scanner, or the like. These and other input devices are often connected to the processing unit 1221 through a serial-port interface 1246 coupled to system bus 1223, but they may be connected through other interfaces not shown in FIG. 5, such as a parallel port, a game port, a universal serial bus (USB), Institution of electrical and electronics engineers IEEE 1394 port, etc. A monitor 1247 or other display device also connects to system bus 1223 via an interface such as a video adapter 1248. In addition to the monitor, personal computer 1221 may include other peripheral output devices such as printer 1275. A print interface 1270 may be connected to system bus 1223 and to printer 1275.

Personal computer 1220 may operate in a networked environment using logical connections to one or more remote computers such as remote computer 1249. Remote computer 1249 may be another personal computer, a server, a router, a network PC, a peer device, or other common network node. It typically includes many or all of the components described above in connection with personal computer 1220; however, only a remote storage device 1250 is illustrated in FIG. 5. The logical connections depicted in FIG. 5 include local-area network (LAN) 1251 and wide-area network (WAN) 1252. Such networking environments are commonplace in offices, enterprise-wide computer networks, intranets and the Internet.

When placed in a LAN networking environment, personal computer 1220 connects to LAN 1251 through a network interface or adapter 1253. When used in a WAN networking environment such as the Internet, personal computer 1220 typically includes modem 1254 or other means for establishing communications over WAN 1252. Modem 1254 may be internal or external to personal computer 1220, and it may connect to system bus 1223 via serial-port interface 1246. In a networked environment, program modules, such as those comprising Microsoft® Word, which are depicted as residing within personal computer 1220 or portions thereof, may be stored in remote storage device 1250. Of course, the network connections shown are illustrative, and other means of establishing a communications link between the computers may be substituted.

An imager 1201 may be connected to system bus 1223. Embodiments of the invention may be operated by personal computer 1220. The imager 1201 may monitor foups as they are transported between processes identifying bad lots.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A Method comprising the steps:
a. detecting a defect in a wafer, the wafer making up one of a plurality of wafers in a lot;
b. assigning a defect code to the wafer based on type of defect and status in process of wafer build; and
c. determining whether to take corrective actions with the lot based on the defect code.

2. The method of claim 1 wherein the defect code indicates whether the failure occurred during test, while in transit, or during a manufacturing step.

3. The method of claim 1, wherein the corrective action may include, reworking the lot, scrapping the lot, or continuing the lot on with the process.

4. The method of claim 1 wherein detecting comprises a visual inspection of the lot.

5. The method of claim 1 wherein detecting comprises an automated process determining an error has occurred.

6. The method of claim 2, wherein the corrective action may include, reworking the lot, scrapping the lot, or continuing the lot on with the process.

7. The method of claim 6, wherein detecting comprises a visual inspection of the lot.

8. The method of claim 6, wherein detecting comprises an automated process.

9. The method of claim 1, further comprising determining whether other lots are affected by the defect.

10. A method comprising the steps of:
a. selecting a scrap code and querying scrapped wafers and lot id lists from a database;
b. querying functional limited yields from the database;
c. using cluster analysis to create a baseline lot population using limited yields;
d. using statistical analysis to compare baseline lot population and lots had scrapped wafers;
e. determining if significant difference between baseline population and lots had scrapped wafers; and
f. adapting a process to reduce errors.

11. The method of claim 10, wherein the statistical analysis is MANOVA.

12. The method of claim 10, further comprising determining if the lots with scrapped wafers affected later lots.

13. A system comprising:
a. an imager adapted to monitor wafers in a lot for errors and identifying where in the process the error occurred;
b. a memory for storing statistical data;
c. a processor for determining whether a lot with a wafer error requires additional processing.

14. The system of claim 13, wherein the processor determines the additional processing that will be implemented.

15. The system of claim 13, further comprising an application program, the application program adapted to perform statistical analysis.

16. The system of claim 15 wherein the application program comprises MANOVA.
